(19) United States
(12) Patent Application Publication
(10) Pub. No.: US 2026/0074872 A1
(43) Pub. Date: Mar. 12, 2026

(54) ARTIFICIAL INTELLIGENCE BASED CHANNEL INPAINTING FOR WIRELESS COMMUNICATION SYSTEMS

(71) Applicant: Samsung Electronics Co., Ltd., Suwon-si (KR)

(72) Inventors: Fan Zhang, Frisco, TX (US); Usman Akram, Austin, TX (US); Yang Li, Plano, TX (US); Xiaochuan Ma, Hillsborogh, NJ (US)

(21) Appl. No.: 19/304,539

(22) Filed: Aug. 19, 2025

Related U.S. Application Data
(60) Provisional application No. 63/693,125, filed on Sep. 10, 2024.

(51) Int. Cl. H04L 5/00

(52) U.S. Cl. CPC H04L 5/0094; H04L 5/005

(57) ABSTRACT

A method includes: transmitting, by a first electronic device, configuration information for sounding reference signals (SRSs) to second electronic devices, the configuration information including non-uniform sampling patterns for the SRSs; receiving, by the first electronic device, non-uniformly sampled SRSs over respective channels from the second electronic devices based on the configuration information; preprocessing the non-uniformly sampled SRSs to extract channel state information of the channels; and reconstructing, using an artificial intelligence model trained to perform channel inpainting, a full band SRS for each of the channels based on the channel state information.

### CROSS-REFERENCE TO RELATED APPLICATION AND CLAIM OF PRIORITY

The present application claims priority under 35 U.S.C. § 119(e) to U.S. Provisional Patent Application No. 63/693,125 filed on Sep. 10, 2024, which is hereby incorporated by reference in its entirety.

### TECHNICAL FIELD

This disclosure relates generally to wireless networks. More specifically, this disclosure relates to artificial intelligence (AI) based channel inpainting in wireless communication systems.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for AI based channel inpainting in wireless communication systems.

In one embodiment, a method is provided. The method includes: transmitting, by a first electronic device, configuration information for sounding reference signals (SRSs) to second electronic devices, the configuration information including non-uniform sampling patterns for the SRSs; receiving, by the first electronic device, non-uniformly sampled SRSs over respective channels from the second electronic devices based on the configuration information; preprocessing the non-uniformly sampled SRSs to extract channel state information of the channels; and reconstructing, using an artificial intelligence (AI) model trained to perform channel inpainting, a full band SRS for each of the channels based on the channel state information.

In another embodiment, a first electronic device is provided. The first electronic device includes a memory and a processor operably coupled to the memory. The processor is configured to: transmit configuration information for SRSs to second electronic devices, the configuration information including non-uniform sampling patterns for the SRSs; receiving, non-uniformly sampled SRSs over respective channels from the second electronic devices based on the configuration information; preprocess the non-uniformly sampled SRSs to extract channel state information of the channels; and reconstruct, using an AI model trained to perform channel inpainting, a full band SRS for each of the channels based on the channel state information.

In yet another embodiment, a non-transitory computer readable medium embodying a computer program is provided. The computer program includes program code that, when executed by a processor of a first electronic device, causes the first electronic device to: transmit configuration information for SRSs to second electronic devices, the configuration information including non-uniform sampling patterns for the SRSs; receiving, non-uniformly sampled SRSs over respective channels from the second electronic devices based on the configuration information; preprocess the non-uniformly sampled SRSs to extract channel state information of the channels; and reconstruct, using an AI model trained to perform channel inpainting, a full band SRS for each of the channels based on the channel state information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of this disclosure;

FIG. 2 illustrates an example gNB according to embodiments of this disclosure;

FIG. 3 illustrates an example UE according to embodiments of this disclosure;

FIG. 4 illustrates an example network device according to embodiment of this disclosure;

FIG. 5 illustrates example antenna beamforming architecture according to embodiments of this disclosure;

FIGS. 6A and 6B illustrate an example process of the AI-based channel inpainting method in accordance with example embodiments of this disclosure;

FIG. 6 illustrates a diagram of an example cyclic prefix (CP)-orthogonal frequency division multiplexing (OFDM) uplink system according to embodiments of this disclosure;

FIGS. 7A and 7B illustrate example SRS sampling patterns in accordance with example embodiments of this disclosure;

FIG. 8 illustrates another example non-uniform SRS sampling pattern in accordance with example embodiments of this disclosure;

FIG. 9 illustrates an example SRS configuration in accordance with example embodiments of this disclosure;

FIGS. 10-12 illustrate an example architecture of an AI model for channel inpainting in accordance with example embodiments of this disclosure;

FIG. 13 illustrates an example timing and frequency offset (TFO) training of the AI model in accordance with example embodiments of this disclosure;

FIGS. 14A-14C illustrate example patch designs in accordance with example embodiments of this disclosure; and

FIG. 15 illustrates a flow chart for an AI-based channel inpainting method according to embodiments of the present disclosure.

### DETAILED DESCRIPTION

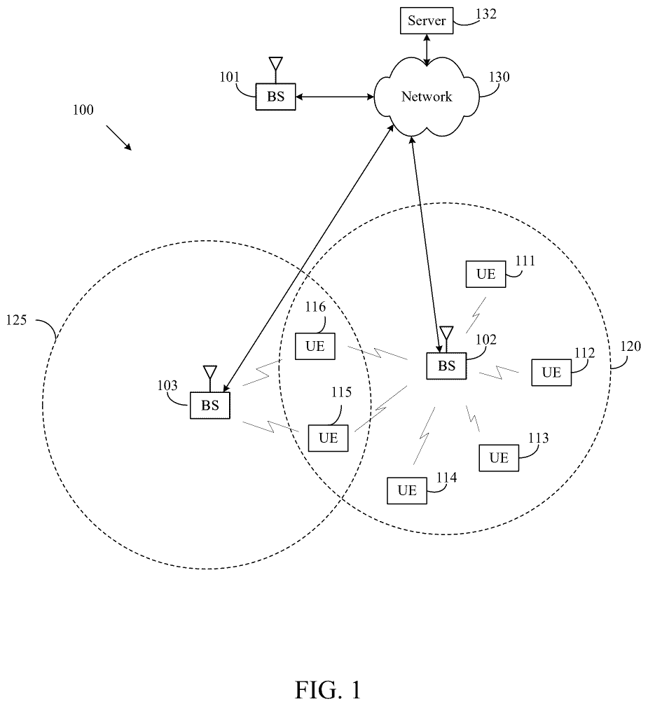

FIGS. 1 through 15, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of this disclosure may be implemented in 5G systems. However, this disclosure is not limited to 5G systems or the frequency bands associated therewith, and embodiments of this disclosure may be utilized in connection with any frequency band. For example, aspects of this disclosure may also be applied to deployment of 5G communication systems, 6G or even later releases which may use terahertz (THz) bands.

FIGS. 1-5 below describe various embodiments implemented in wireless communications systems and with the use of orthogonal frequency division multiplexing (OFDM) or orthogonal frequency division multiple access (OFDMA) communication techniques. The descriptions of FIGS. 1-5 are not meant to imply physical or architectural limitations to the manner in which different embodiments may be implemented. Different embodiments of this disclosure may be implemented in any suitably arranged communications system.

FIG. 1 illustrates an example wireless network according to embodiments of this disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

The wireless network 100 may be an artificial intelligence (AI)-based wireless communication system. As such, the at least one network 130 may be operably coupled to an electronic device (e.g., without limitation, a network server) 132 configured to, for example and without limitation, receive data from the gNBs 101-103 via backhaul/network interfaces and train an AI model to perform channel estimation. The server 132 may represent one or more servers, and each server 132 includes a suitable computing or processing device for training the AI model. Each server 132 could, for example, include one or more processing devices, one or more memories storing instructions and data, and one or more network interfaces to receive the data. The AI model is then trained and deployed to effectively perform channel estimation for reliable and efficient communications in the wireless communication network 100.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, to support AI-based channel inpainting in wireless communication systems. In certain embodiments, one or more of the gNBs 101-103 include circuitry, programing, or a combination thereof, to utilize data for AI model training in cellular systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

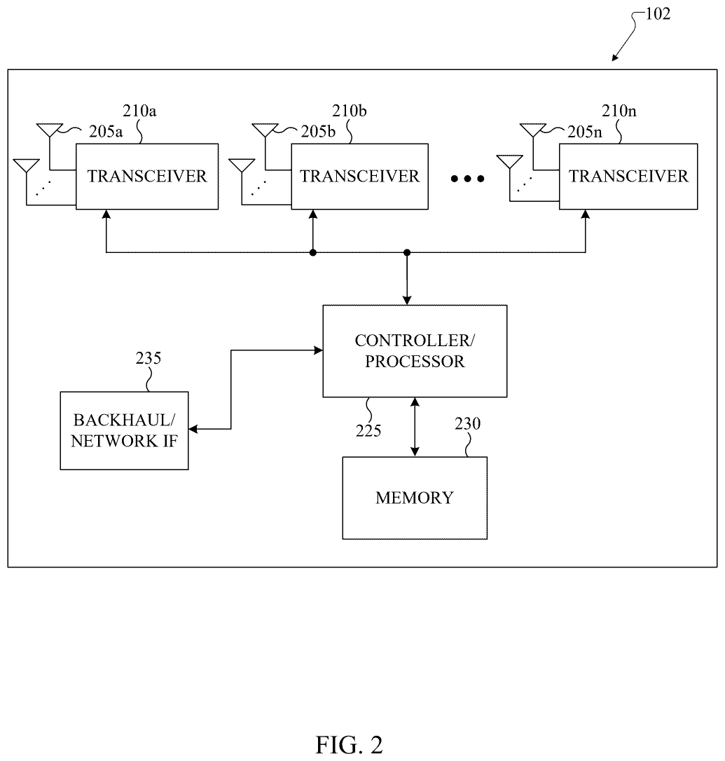

FIG. 2 illustrates an example gNB 102 according to embodiments of this disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS and, for example, processes to perform AI-based channel inpainting in wireless communication systems as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

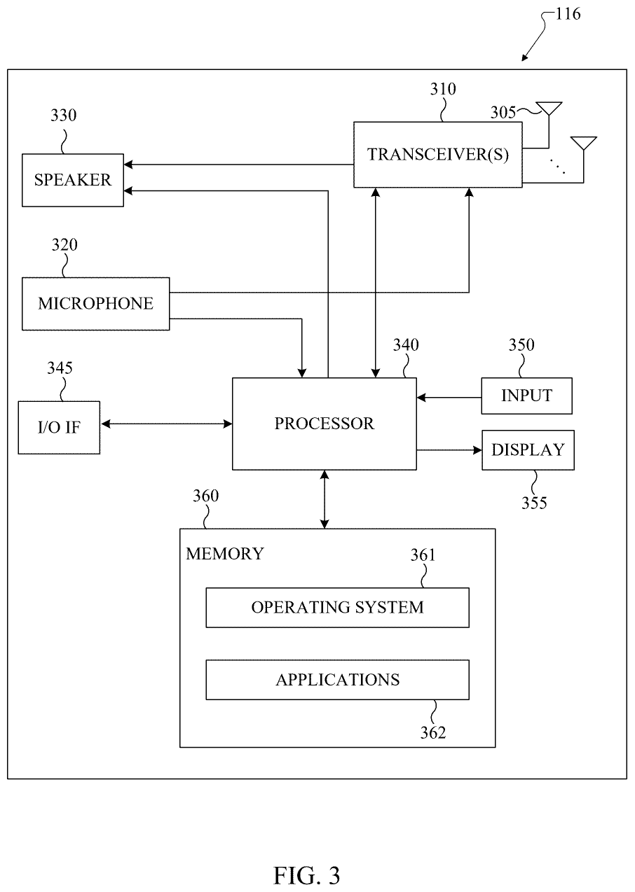

FIG. 3 illustrates an example UE 116 according to embodiments of this disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes to support AI-based channel inpainting in wireless communication systems as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

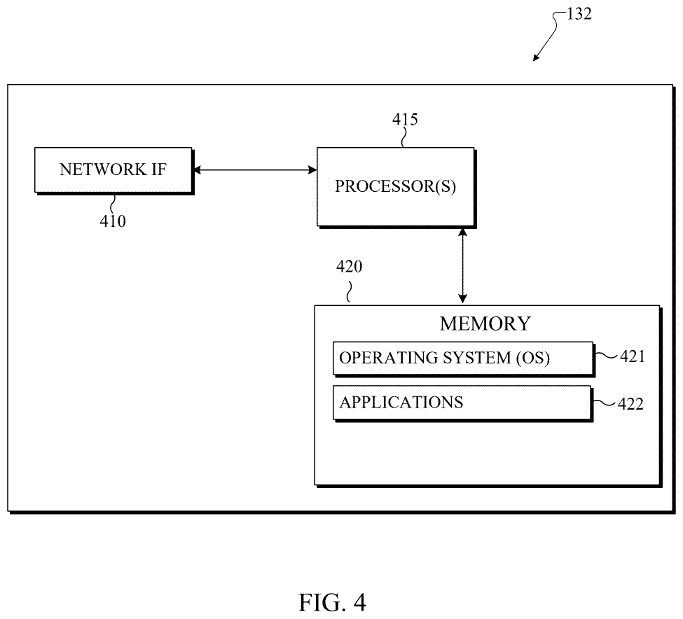

FIG. 4 illustrates an example network server 132 according to embodiments of this disclosure. The embodiment of the server 132 illustrated in FIG. 4 is for illustration only. Different embodiments of servers 132 could be used without departing from the scope of this disclosure.

The server 132 may be a computing device including at least a network interface 410, a processor 415 and a memory 420. The network interface 410 may support communications over any suitable wired or wireless connection(s). It may include any suitable structure supporting communications over a wired or wireless connection, such as an Ethernet or transceiver. The network interface 410 may be, for example and without limitation, network interface cards (NICs) or network ports. The server 132 may receive data from the gNBs 101-103 via the network interface 410 and the UEs 111-116 via the gNBs 101-103.

The processor 415 is coupled to the network interface 410 and can include one or more processors or other processing devices. The processor 415 can execute instructions that are stored in the memory 420, such as the OS 421 in order to control the overall operation of the server 132. The processor 415 can include any suitable number(s) and type(s) of processors or other devices in any suitable arrangement. For example, in certain embodiments, the processor 415 includes at least one microprocessor or microcontroller. Example types of processor 415 include microprocessors, microcontrollers, digital signal processors, field programmable gate arrays, application specific integrated circuits, and discrete circuitry. In certain embodiments, the processor 415 can include a neural network as well as a CPU, a GPU or a tensor processing unit (TPU) that provides significant computational resources required for training the neural network.

The processor 415 is also capable of executing other processes and programs resident in the memory 420, such as operations that receive and store data. As described in greater detail below, the processor 415 may execute processes to train an AI model to perform channel estimation in the wireless communication systems. The processor 415 can move data into or out of the memory 420 as required by an executing process. In certain embodiments, the processor 415 is configured to execute the one or more applications 422 based on the OS 421 or in response to signals received from external source(s) or an operator. Example applications 422 can include an AI training application for an AI model.

The memory 420 is coupled to the processor 415. Part of the memory 420 could include a RAM, and another part of the memory 420 could include a Flash memory or other ROM. The memory 420 can include persistent storage (not shown) that represents any structure(s) capable of storing and facilitating retrieval of information (such as data, program code, and/or other suitable information). For example, the storage may include data prepared for training of the AI model. The memory 420 can contain one or more components or devices supporting longer-term storage of data, such as a read only memory, hard drive, Flash memory, or optical disc.

Although FIG. 4 illustrates one example of the server 132, various changes can be made to FIG. 4. For example, various components in FIG. 4 can be combined, further subdivided, or omitted and additional components can be added according to particular needs. As a particular example, the processor 415 can be divided into multiple processors, such as one or more central processing units (CPUs), one or more graphics processing units (GPUs), one or more neural networks, and the like.

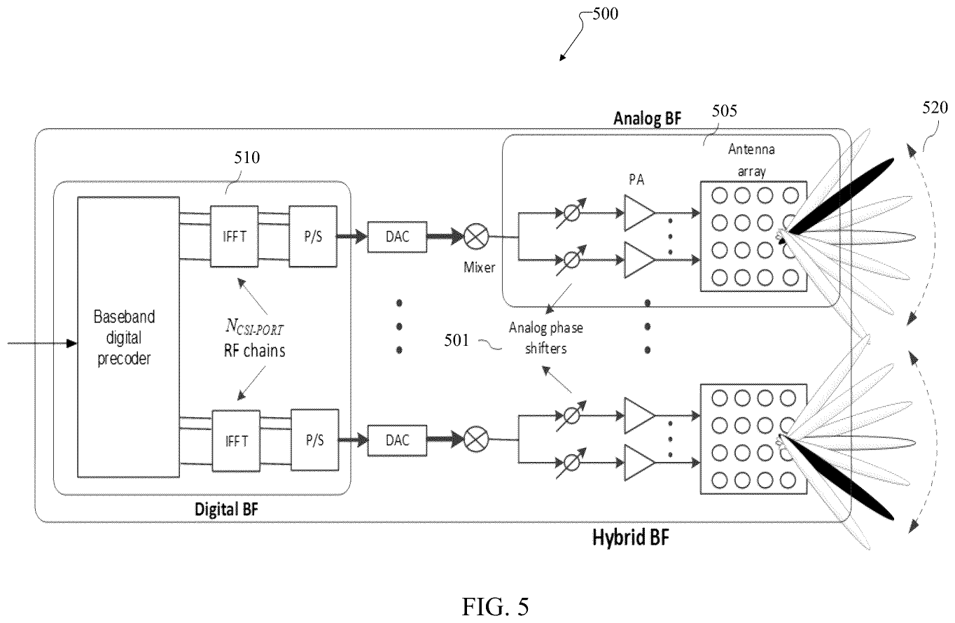

FIG. 5 illustrates an example antenna beamforming architecture 500 according to embodiments of this disclosure. The embodiment of the antenna beamforming architecture illustrated in FIG. 5 is for illustration only. Different embodiments of an antenna beamforming architecture could be used without departing from the scope of this disclosure.

In the example of FIG. 5, one CSI-RS port is mapped onto a large number of antenna elements which can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or subframes or slots (wherein a subframe or a slot comprises a collection of symbols and/or can comprise a transmission time interval). The number of sub-arrays (equal to the number of RF chains) is the same as the number of CSI-RS ports N_{CSI-PORT}. A digital beamforming unit 510 performs a linear combination across N_{CSI-PORT} analog beams to further increase precoding gain. While analog beams are wideband (hence not frequency-selective), digital precoding can be varied across frequency sub-bands or resource blocks.

Although FIG. 5 illustrates one example antenna beamforming architecture 500, various changes may be made to FIG. 5. For example, various components in FIG. 5 could be combined, further subdivided, or omitted and additional components could be added according to particular needs.

In modern wireless systems, such as those described regarding FIGS. 1-5, there may be two main modes for beam-forming: (i) a reciprocity-based beam-forming (e.g., using a sounding reference signal (SRS)); and (ii) a codebook-based beam-forming (e.g., based on a precoding matrix indicator (PMI)). As a codebook may be quantized, the SRS can provide a more accurate channel state information (CSI), which would benefit precoding, channel prediction, etc. However, obtaining a high quality SRS may be difficult due to various challenges. There may be two main challenges to this: a low coverage and a limited SRS resource. Regarding the low coverage, the SRS-based mode may perform worse than the PMI-based mode in a low signal to noise ratio (SNR) setting. Hence, in order to utilize the benefit of the SRS, a UE may not be far from a base station due to the restrictions associated with the transmit power and high path loss. With respect to the limited SRS resource, 5G standards have already defined possible SRS allocation slots. Besides, introducing more SRSs may result in a more overhead.

This disclosure describes an AI-based channel inpainting method for performing a non-uniformly sampled SRS recourse allocation and reconstruction of a full band channel (a full SRS band) from a partial sub-band information (a smaller sounded SRS band or a sparse SRS band). By utilizing the sparsity in a transform domain (e.g., the delay and/or angular domains) while achieving a desirable performance-complexity tradeoff, the AI-based channel inpainting method may significantly increase the accuracy and reliability of the channel estimation for beamforming in comparison to those of the other channel estimation models. Further, this disclosure provides an AI architecture that provides denoising treatments tailored to the varying characteristics of the channel parts so as to reduce the computational complexity in the transform domain. In addition, this disclosure improves the performance of the AI model by providing a mixed-SNR training based on improved one or more loss functions, leading to significant savings in the model storage and improving the in-field implementation of the AI model. Moreover, the AI-based channel inpainting method according to this disclosure employs additional physics informed features as the input to the AI model, thereby further improving the channel estimation accuracy.

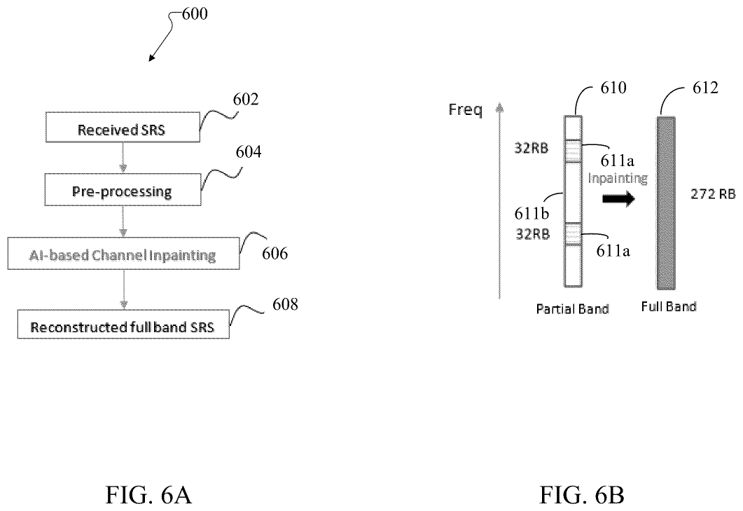

FIGS. 6A-15 illustrate non-limiting embodiments of the AI-based channel inpainting method, the resultant benefits, and related concepts thereof in greater detail in accordance with this disclosure.

FIGS. 6A and 6B illustrate an example process of the AI-based channel inpainting method 600 in accordance with example embodiments of this disclosure. For ease of explanation, the process shown in FIGS. 6A-6B is described as being performed using the devices (and components) of the wireless network 100 shown in FIG. 1. However, the process illustrated FIGS. 6A and 6B may be performed using any other suitable device(s) and in any other suitable system(s).

As illustrated in the example of FIG. 6A, the AI-aided inpainting 600 may include a receive operation 602, a pre-processing operation 604, a channel-inpainting operation 606, and a reconstruction operation 608. At the receive operation 602, a first electronic device (e.g., a base station 101-103 of FIGS. 1 and 2) may receive a non-uniformly sampled SRS from a second electronic device (e.g., a UE 111-116 of FIGS. 1 and 3). The base station may configure one or more UEs with non-uniformly sampled SRSs and transmit the configuration to the one or more UEs via, e.g., an RRC signaling. The one or more UEs in turn may transmit the non-uniformly sampled SRS to the base station. At the pre-processing operation 604, the base station may perform pre-processing of the received SRS. This may include, for example, a Zadoff-Chu sequence removal, a timing/frequency offset compensation, and a cyclic shift removal. At the channel inpainting operation 606, the base station may perform, using an AI model (remote or local), channel inpainting on a model input. The model input may include a partial band signal (a sparse SRS band) 610. As shown in FIG. 6B, a sparse SRS band 610 may include a combined partially-sounded-sub-bands from allocated resource symbols for the UE. For example, upon receiving the non-uniformly sampled SRS, the base station may identify a sub-band including the SRS in each of the allocated resource symbols, and combine the identified sub-bands to generate the sparse SRS band 610. The unsounded portions 611b of the sparse SRS band 610 may be masked. The sounded portions 611a may represent a pilot (a known and/or estimated SRS). The AI-model may then receive the sparse SRS band 610 as the model input to perform channel inpainting. At the reconstruction operation 608, the AI model may reconstruct a full band SRS 612 and output the reconstructed full band SRS as shown in FIG. 6B. The full band SRS 612 may be used for performing a wireless communication task such as beam forming.

Although FIGS. 6A and 6B illustrate one example process for the AI-aided channel inpainting, various changes may be made to FIGS. 6A and 6B. For example, various components or operations in FIGS. 6A and 6B may be combined, further subdivided, replicated, omitted, or rearranged and additional components or functions may be added according to particular needs. Also, while the SRS is sounded in 32 allocated resource blocks in each sub-band in FIG. 6B, the SRS may be sounded in more or less allocated resource blocks.

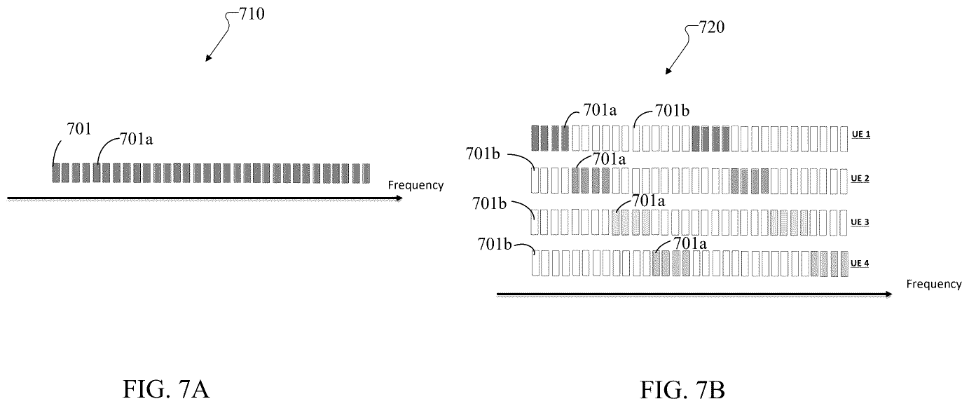

FIGS. 7A and 7B illustrate example SRS sampling patterns 710 and 720 in accordance with example embodiments of this disclosure. For ease of explanation, the example patterns 710 and 720 as shown in FIGS. 7A and 7B are described as being configured by using the devices (and components) of the wireless network 100 shown in FIG. 1. However, the example patterns 710 and 720 illustrated FIGS. 7A and 7B may be configured using any other suitable device(s) and in any other suitable system(s).

As illustrated in the example pattern of FIG. 7A, the SRS can have a uniform sampling pattern 710. That is, the SRS in the uniform sampling pattern 710 may be a full band SRS, i.e., the SRS sounded in the entirety of the allocated resources. Each portion 701 may represent one SRS unit. As illustrated in the example patterns of FIG. 7B, the SRSs can have non-uniform sampling patterns 720. The non-uniform patterns 720 of FIG. 7B may be illustrated to support four second electronic devices (e.g., the UE 111-116 of FIGS. 1 and 3) to satisfy the current standards (e.g., TS 138 211—V18.2.0 and TS 138 214—V18.2.0). Compared to the uniformly sampled SRS of FIG. 7A, since the number of transmit units is ¼, an additional 6-dB power boost may be made to help increase the cell coverage.

As illustrated in FIG. 7B, each of the four second electronic devices may receive a non-uniformly sampled SRS over respective allocated resources. As previously mentioned, each portion 701 may represent one SRS unit and can be a sounded portion 701a or an unsounded, masked portion 701b. The non-uniform patterns 720 may include respective masking patterns. The non-uniformly sampled SRS for each UE may have one masking pattern, and the non-uniformly sampled SRSs for the four UEs collectively may have one masking pattern with a frequency hopping as illustrated in FIG. 7B. For this SRS pattern, it may be assumed that a total number of sounded SRS units may be M. The start and end indices of UE k(1≤k≤K) in sub-band n (0≤n≤N−1) may then be:

$${I}_{start} = round ( \frac{M}{KN} , 4 ) ( nK - 1 + k ) ,$$

$${I}_{end} = round ( \frac{M}{KN} , 4 ) ( nK + k ) - 1$$

Here, K may represent the number of the UEs that need to be multiplexed and N may represent the number of sounded sub-bands. The round-4 function may be applied here because the current standards, that only support multiples of 4 resource block assignment.

In some embodiments, other multiplexing algorithm(s) may be utilized. For example, cyclic shift (CS) and comb algorithms may be utilized to increase the SRS capacity. In this disclosure, the UEs may be assigned to the same CS and comb. However, this is for illustrative purposes only, and thus the UEs may be assigned to different CSs and/or combs as appropriate without departing from the scope of this disclosure.

Although FIG. 7B illustrates one example SRS sampling pattern for multiplexing four UEs, any other SRS sampling patterns in compliance with the relevant standards can be used for channel inpainting.

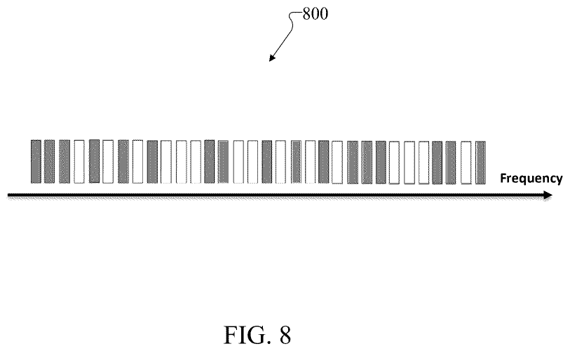

FIG. 8 illustrates another example non-uniform SRS sampling pattern 800 in accordance with example embodiments of this disclosure. For ease of explanation, the example pattern 800 as shown in FIG. 8 is described as being configured by using the devices (e.g., the base station 101-103 of FIGS. 1 and 2) of the wireless network 100 shown in FIG. 1. However, the example pattern 800 illustrated in FIG. 8 may be configured using any other suitable device(s) and in any other suitable system(s)

For 5G beyond or possible 6G standards, there may not be such a constraint requiring support for only the multiples of 4 resource block assignment or a looser constraint may be imposed. In such cases, the example pattern 800 with a random positioning can be used. While uniform and low sampling rate may cause alias(es) in the transformation domain, the SRS channel may be sparse in the delay domain. This may allow, for example, using a non-uniformly sampling over a frequency (e.g., a frequency hopping) and at a rate lower than the Nyquist sampling rate (which may be for all signals) to this delay domain sparse SRS signals. While this sampling pattern may not be currently supported in 5G standards, one simple change to the current standards may be to make one SRS resource set that can include disjointed SRS resources.

Although FIG. 8 illustrates one example of SRS sampling patterns without the 4-UE resource assignment constraints, any other SRS sampling patterns without such constraints in compliance with the relevant standards can be used for channel inpainting.

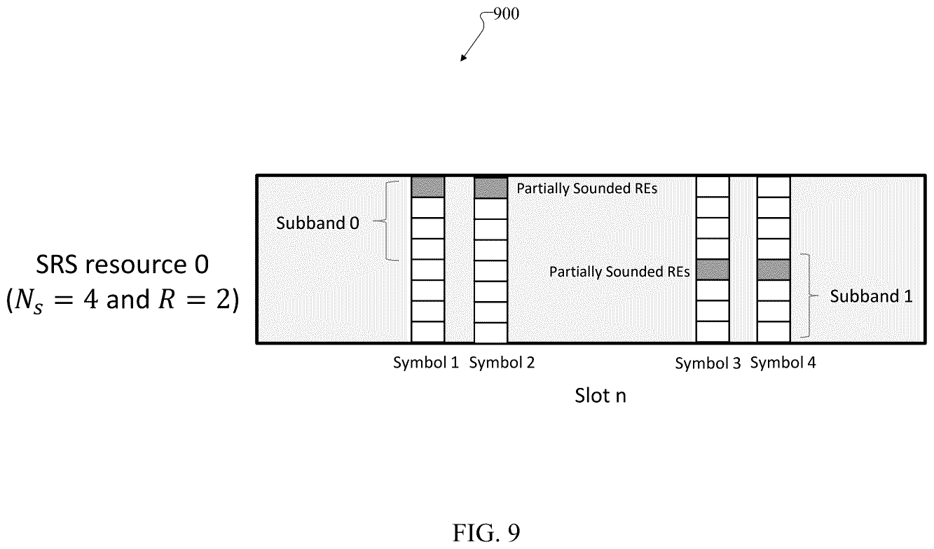

FIG. 9 illustrates an example SRS configuration 900 in accordance with example embodiments of this disclosure. For ease of explanation, the SRS configuration 900 shown in FIG. 9 is described as being configured using the devices (e.g., the base station 101-103 of FIGS. 1 and 2) of the wireless network 100 shown in FIG. 1. However, the SRS configuration 900 illustrated FIG. 9 may be configured using any other suitable device(s) and in any other suitable system(s).

The first electronic device (e.g., the base station 101-103 of FIGS. 1 and 2) may configure a second electronic device (e.g., the UE 111-116 of FIGS. 1 and 3) with an SRS with intra-slot frequency hopping within a bandwidth part. In some embodiments, a base station may configure a UE to partially sound on each sub-band (not available in Rel-15). A drawback to these configurations may include a limited sub-sampling pattern.

The first SRS resource at index 0 may span 4 OFDM symbols (Nₛ=4) with repetition factor (R) of 2 at slot n as illustrated in FIG. 9. For the OFDM symbols 1 and 2, the SRS may be partially sounded at sub-band 0. For the OFDM symbols 3 and 4, the SRS may be partially sounded at sub-band 1. The partial sounded SRS on the difference OFDM symbols in a same slot should be combined for channel inpainting. As such, the sub-band 0 of OFDM symbols 1 and 2 may be combined with the sub-band 1 of OFDM symbols 3 and 4 to generate a sparse SRS band. The generated sparse SRS band may then be input to an AI model for channel inpainting.

Note that the partial SRS sounding can occupy 25% or 50% of the total REs and the number of sounded SRS on each OFDM symbol may be a multiple of six. Further, the intra-slot hopping may assume that Nₛ can be divisible by R.

Although FIG. 9 illustrates one example of SRS configuration 900, an SRS may have different configurations in compliance with the relevant standards.

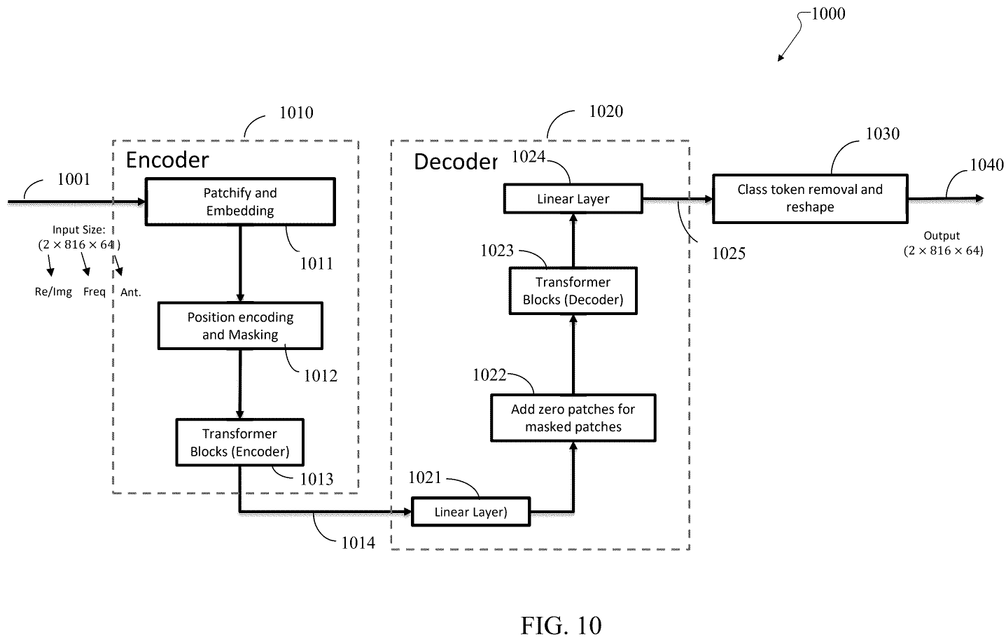

FIGS. 10-12 illustrate an example architecture of an AI model 1000 for channel inpainting in accordance with example embodiments of this disclosure. For ease of explanation, the architecture shown in FIGS. 10-12 is described as being a part of and/or performed using the devices (and components) of the wireless network 100 shown in FIG. 1. However, the architecture 800 illustrated FIGS. 10-12 may be remote and/or performed using any other suitable device(s) and in any other suitable system(s).

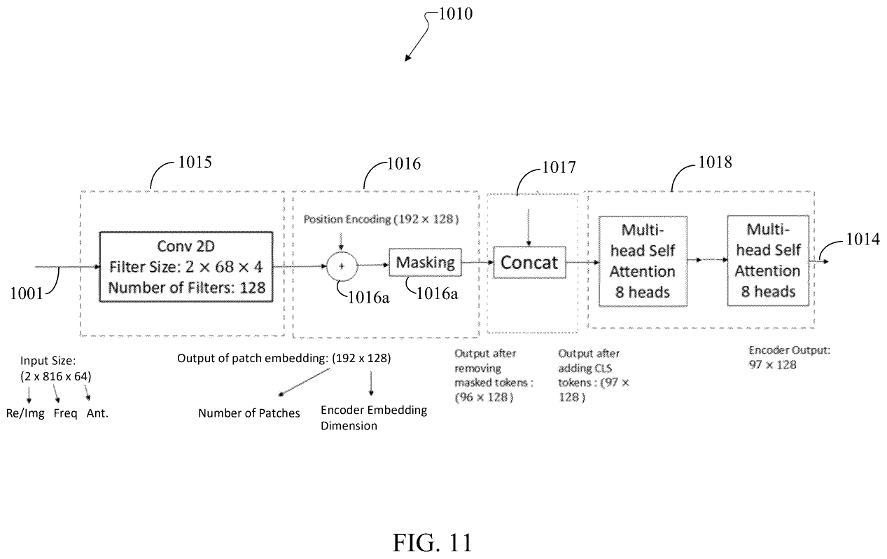

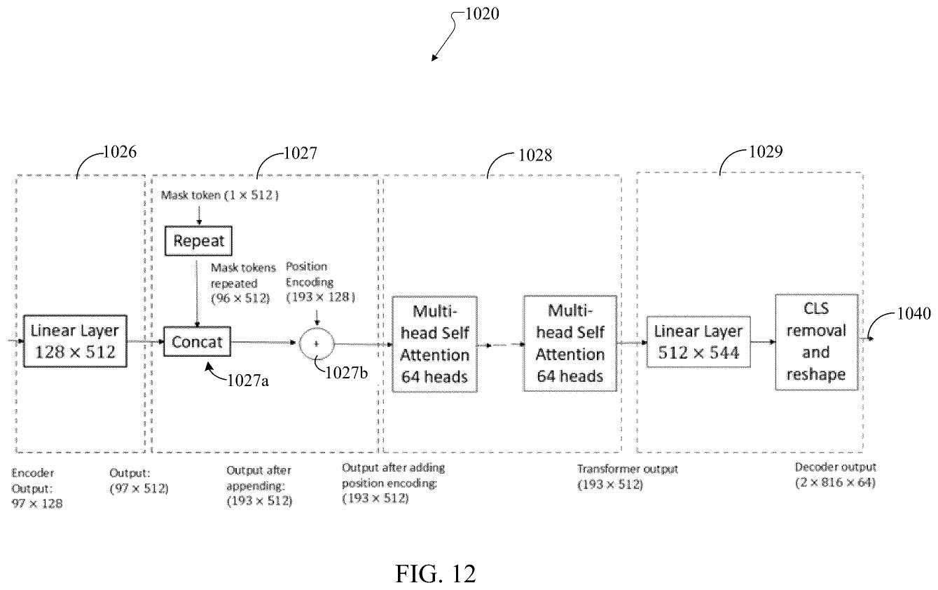

In the example architecture as illustrated in FIG. 10, the AI model 1000 may include an encoder 1010 and a decoder 1020. FIGS. 11 and 12 illustrate the encoder 1010 and the decoder 1020, respectively, in further detail.

The encoder 1010 may receive an input signal (a model input) 1001 from the first electronic device (e.g., the base station 101-103 of FIGS. 1 and 2) via a transceiver 210a-210n. The model input 1001 may be a sparse SRS band including a masked portion(s). In one embodiment, for the model input 1001, the masked signal may be in the antenna frequency domain and the masked portion(s) may be represented by 0. For example, if the masking ratio is 75%, there may be 204 non-zero resource elements (REs) out of 816 REs for a 100-MHz-channel comb-4 SRS.

In another embodiment, an inverse FFT may be applied to the unmasked band (portion(s)) of the sparse SRS band to obtain a delay domain signal. The delay domain signal may be attached to the original antenna and frequency domain signal, increasing the input dimension (e.g., from 2×816×64 to 4×816×64). Here, the input dimension is indicated as (a number of input channels)×(a number of REs)×(a number of antennas). In the input dimension of 2×816×64, there are two input channels that correspond to the real and imaginary parts, 816 REs, and 64 antennas. This is for illustrative purposes only, and thus input dimensions can vary as appropriate without departing from the scope of this disclosure.

The encoder 1010 may then patchify 1011 a two-dimensional (2D) image of the model input 1001 into a plurality of patch embeddings, mask 1012 the patch embeddings combined with positional encodings, and process 1013 the unmasked portions using transformer blocks (e.g., vision transformers). Optionally, a class token (CLS) may be prepended to a sequence of the patch embeddings to aggregate global information across the patches via self-attention and generate a single representation for the 2D image.

The decoder 1020 may receive the encoder output 1014, linearly project 1021 the encoder output 1014 to match the decoder dimensions. The decoder 1020 may then add 1022 zeroes to the projected output to generate a vector sequence representing the unmasked patch embeddings and the masked patch embeddings. The decoder 1020 may then process 1023, using transformer blocks, the vector sequence to predict the SRS for the masked patch embeddings based on self-attention and reconstruct a full band SRS based on the processed vector sequence. The decoder 1020 may next linearly project 1024 and output the reconstructed full band SRS 1025. If a CLS has been prepended at the encoder 1010, the AI model 1000 may optionally remove 1030 the CLS and reshape the vector sequence to match the original model input 1001 or a desired output format (e.g., 2D image grid).

The AI model 1000 may output the reconstructed full band SRS 1040 (or the reshaped vector sequence) for downstream wireless communication tasks. Note that the model output (i.e., the reconstructed full band SRS 1040) may have the same dimension (2×816×64) as the model input 1001.

The example encoder 1010 as illustrated in FIGS. 10 and 11 may include: a patch embedding module 1015, a position encoding and masking module 1016, a class token appending module 1017, and a concatenated vanilla transformer module 1018. A 2D image of the model input 1001 may be fed to the patch embedding module 1015. The 2D image may be an antenna and frequency response converted to a sequence of patch embeddings (vectors).

The model input 1001 may have a 2×816×64 dimension. The patch embedding module 1015 may include a 2D convolutional network (Cony 2D). A patch embedding may refer to a process of dividing the 2D image of the model input 1001 into non-overlapping patches and transforming each patch into a fixed-size feature vector (a patch embedding) that can be processed by subsequent modules such as the transformer module 1018.

The Conv 2D may process the 2D image and generate the feature vectors for each patch. The Conv 2D may have 128 filters. Each filter may have a size [H, W, C], where H refers to height, W refers to width and C refers to a number of the input channels. That is, each filter may have a height spanning 2 pixels, a width spanning 68 pixels, and four input channels. The Conv 2D may apply the 128 filters, convolving over the 2D input image and output patch embeddings. The output from the patch embedding module 1015 may have 192 patches (tokens) in the sequence of the patch embeddings and 128 dimensionality of each patch embedding. This output may be fed to the position encoding and masking module 1016. The patch size may be 34×4 (34 resource blocks×4 antennas) and be designed as rectangular in order to make the patches fit the unequal numbers of antennas and resource blocks.

The position encoding and masking module 1016 may include a position encoder 1016a and a masker 1016b. The position encoder 1016a may receive the output from the patch embedding module 1015 and add positional embeddings to the patch embeddings. The masker 1016b may then mask the unsounded portions of the sparse SRS band 1001 and output the patch embeddings without the masked patch embeddings. Masking may be a technique used to remove a subset of the input patches before the encoder processing. The output after masking here may have 96 patches remaining with 128 dimensionality.

Optionally, the output from the position encoding and masking module 1016 may be input to the CLS token appending model 1017 to concatenate a CLS to the patch embeddings. The output after adding the CLS may then result in 97 patches with 128 dimensionality. It has been shown that the CLS may not have a significant or meaningful performance impact. Hence, the prepending of the CLS to the sequence of the patch embeddings can be skipped.

The input to the transformer module (transformer blocks) 1018 may only include the unmasked patch embeddings. The concatenated vanilla transformer module 1018 may include, e.g., four transformer blocks and process the unmasked portion(s) of the sparse SRS band by performing multi-head self-attention (e.g., 8 attention heads) by each transformer block. The transformer module 1018 may then output an encoder output 1014. The encoder output 1014 may include the 97 patches with 128 dimensionality.

In another embodiment, a masking block can also be attached before the patch embedding module 1015.

The example decoder 1020 as illustrated in FIGS. 10 and 12 may include: a decoder embedding module 1026, a position encoding and mask token appending module 1027, a concatenated vanilla transformer module 1028, and an output layer module 1029. The decoder 1020 may reconstruct the full sequence of the 192 patches (representing the entirety of the model input 1001) output from the patch embedding module 1015 of the encoder 1010. The decoder embedding module 1026 may include a linear layer configured to apply a linear transformation from the 128 dimensional patch embeddings from the encoder 1010 into 512-dimensional patch embeddings. It may receive the 97 remaining patch embeddings with 128 dimensionality from the encoder 1010 and output the 97 patch embeddings with 512 dimensionality.

The position encoding and mask token appending module 1027 may include mask token appender 1027a and a position encoder 1027b. The mask token appender 1027a may generate a mass token by adding zeros to the positions at which the patches are masked. The mask token may have a shape of 1×512. The mask token appender 1027a may repeat the mask token (zero vectors) generation for each of the masked patches and concatenate the mask tokens to the unmasked, sounded patch embeddings, restoring the vector sequence to its full length. The position encoder 1027b may then add the position embeddings to the vector sequence. The output vector sequence may represent 193 patch embeddings with 512 dimensionality after the mask token concatenation and position encoding addition.

The transformer module 1028 may process the output from the position encoding and mask token appending module 1027 based on multi-head self-attention with, e.g., 64 attention heads by each transformer block to predict the unsounded portion(s) of the sparse SRS band based on the sounded portion(s) of the sparse SRS band. The transformer module 1028 may output the vector sequence representing 193 patches with 512 dimensionality.

The output layer module 1029 may remove the CLS and output the final full band SRS 1040. The decoder output 1040 may have the same dimension as the model input 1001.

During training of the AI model 1000, the loss function having different variations such as normalized mean square error (NMSE) and cross correlation (Xcorr) may be applied. The target of calculating the loss function may be chosen according to a specific wireless communication task at hand.

In one embodiment, the AI model 1000 may be trained also performing denoising task to the sounded band.

In one embodiment, a loss function NMSE may be applied to all patches, masked or unmasked portions.

In another embodiment, in order to balance between the loss of a high SNR and a low SNR, the following SNR-based NMSE may be applied over only the masked portions of the sparse SRS:

$$loss = \{ \begin{matrix}\sqrt{NMSE} , & SNR > 0 dB \\ NMSE , & SNR \leq 0 dB\end{matrix}$$

This may be more suitable when the input is noiseless or almost noiseless.

Note that the best model architecture for this task might not be conclusive, and there might exist other architectures (either with totally different neural network classes or adjustments on the model hyperparameters) with a better performance on the same dataset or on different simulated and/or real-measurement datasets. The constructed path dataset and the generic training and inference procedure, however, may not change significantly, rendering convenient the uses of other models (i.e., fast algorithm upgrade) and allowing the key ideas presented in this disclosure to hold for all algorithms.

Although FIGS. 10-12 illustrate one example of the AI model 1000 for channel inpainting, various changes may be made to FIGS. 10-12. For example, various components or operations in FIGS. 10-12 may be combined, further subdivided, replicated, omitted, or rearranged and additional components or functions may be added according to particular needs. Also, transformers other than vision transformers may be utilized to perform channel inpainting as appropriate without departing from the scope of this disclosure.

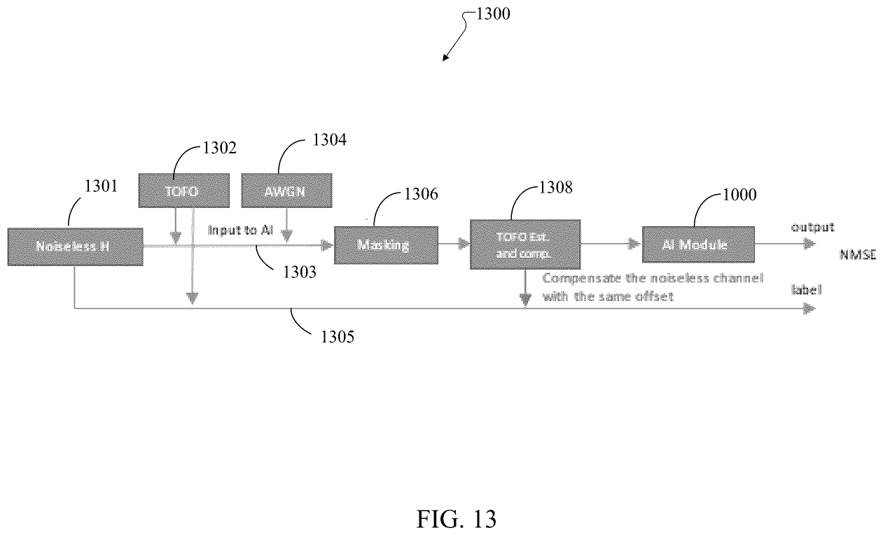

FIG. 13 illustrates an example timing and frequency offset (TFO) training 1300 of the AI model 1000 in accordance with example embodiments of this disclosure. For ease of explanation, the example TFO training 1300 is described as being performed using the devices (e.g. the server 132) of the wireless network 100 shown in FIG. 1. However, the example training 1300 may be performed using any other suitable device(s) and in any other suitable system(s).

As a first electronic device (e.g., a base station 101-103 of FIGS. 1 and 2) and a second electronic device (e.g., a UE 111-116 of FIGS. 1 and 3) cannot perfectly synchronize in time, there may exist a TFO in an SRS. An AI model may be sensitive to such TFO impairment.

Pre-processing modules (e.g., a processor 225, 340) for the base station and the UE may include a TFO estimation and compensation module. However, such a TFO estimation and compensation module may not remove all impairments, and thus have some residuals. These residuals may degrade the reconstruction performance of an AI model. The example FTO training 1300 may be provided in order to render the reconstruction robust to the TFO impairment.

In one embodiment, the noiseless channel 1301 may be first injected with a TFO impairment 1302 to both a model input 1303 to an AI model 1000 and an input 1305 to a label generator. Further, a white Gaussian noise 1304 may be added to the model input 1303. Masking 1306 in frequency may be applied to the noisy channel afterwards. In addition, the TFO estimation and compensation 1308 may be applied to the model input 1303 and the input 1305 to the label generator, thereby aligning the model input 1303 and the labels in time and frequency.

In this way, the AI model 1000 can learn the residuals for the TFO estimation and compensation used in the training. Note that for different algorithms applied for TFO estimation and compensation 1308, the AI model 1000 may need to be trained differently.

Although FIG. 13 illustrates one example TFO training 1300 for channel inpainting, various changes may be made to FIG. 13. For example, various components or operations in FIG. 13 may be combined, further subdivided, replicated, omitted, or rearranged and additional components or functions may be added according to particular needs.

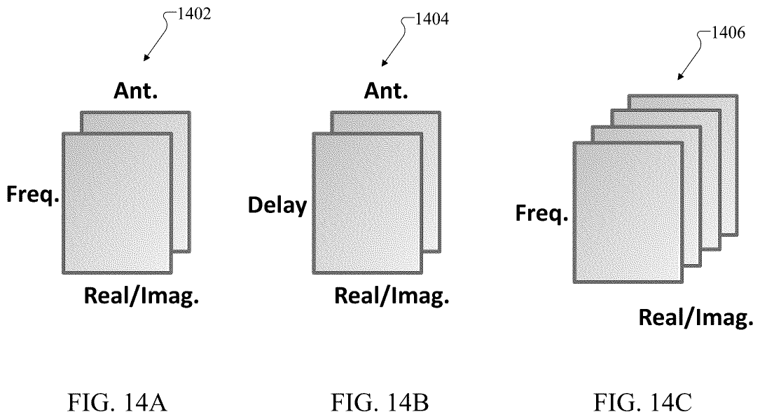

FIGS. 14A-14C illustrate example patch designs 1402, 1404, 1406 in accordance with example embodiments of this disclosure. Although FIGS. 14A-14C illustrate three example patch designs 1402, 1404 and 1406, these are for illustrative purposes only, and thus different example patch designs may be utilized for channel inpainting by an AI model as appropriate without departing from the scope of this disclosure.

The original input to an AI model may be in the frequency and antenna domain. During the patchifying process, patches may be designed in various manners. The patchifying process may refer to a process of dividing the 2D input image into a plurality of patches to generate patch embeddings.

In the example embodiment as illustrated in FIG. 14A, the patch design 1402 may allow the patches to maintain the frequency and antenna domain. As such, the two input channels (real and imaginary) may be patchified in the frequency and antenna domain as illustrated in FIG. 14A.

In another example embodiment as illustrated in FIG. 14B, after the patchifying process, the patch design 1404 may be obtained by applying the Discrete Fourier Transform (DFT) to the frequency domain of a patch to convert the patch into the delay domain.

In yet another example embodiment as illustrated in FIG. 14C, after the patchifying process, the patch design 1406 may be obtained by applying the DFT to the frequency domain of a patch, and concatenate the patch to the original frequency-antenna-domain input.

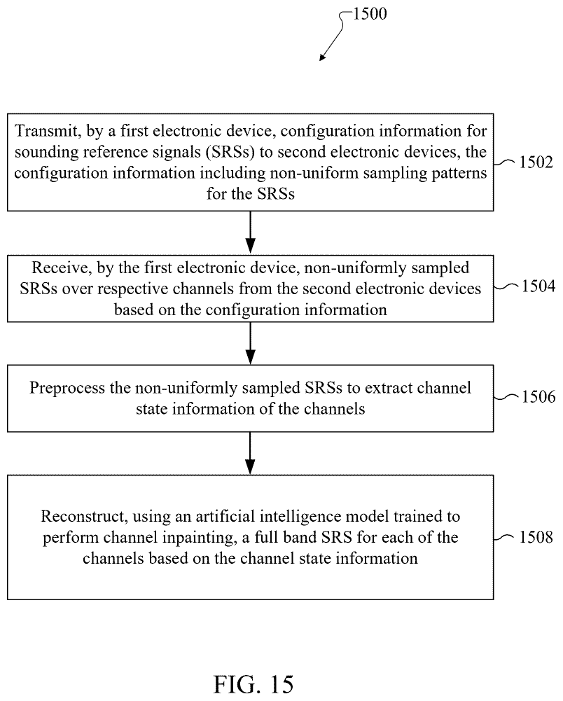

FIG. 15 illustrates a flow chart for an AI-based channel inpainting method 1500 according to embodiments of this disclosure. The embodiment of the AI-based channel inpainting method in FIG. 15 is for illustration only. Other embodiments of an AI-based channel inpainting method may be used without departing from the scope of this disclosure. In the example of FIG. 15, the AI-based channel inpainting method 1500 may be performed by a first electronic device (such as a base station 101-103 of FIGS. 1 and 2).

In the example of FIG. 15, the method 1500 begins at step 1502. At step 1502, the first electronic device may transmit configuration information for SRSs to second electronic devices (e.g., UEs 111-116 of FIGS. 1 and 3). The configuration information may include non-uniform sampling patterns for the SRSs. At step 1504, the first electronic device may receive non-uniformly sampled SRSs over respective channels from the second electronic devices based on the configuration information. At step 1506, the first electronic device may preprocess the non-uniformly sampled SRSs to extract channel state information of the channels.

At step 1508, the first electronic device may reconstruct, using an AI model, a full band SRS for each of the channels based on the channel state information. The AI model may be trained to perform channel inpainting. The AI model may be trained by at least one of: calculating a loss function using at least one of a sounded portion of the sparse SRS band or an unsounded portion of the sparse SRS band; or denoising the sounded portion of the sparse SRS band. Further, the AI model may be trained by injecting a noiseless channel with a TFO impairment to a model input to the AI model and an input to a label generation module, the model input comprising the sparse SRS band; adding noise to the model input; masking an unsounded portion of the sparse SRS band; applying a TFO estimation and compensation to the model input; compensating generated labels with the TFO estimation; and aligning the model input and the labels in time and frequency.

In one embodiment, the method 1500 may further include: dividing a 2D image of the sparse SRS band into patches to generate patch embeddings; masking patch embeddings representing an unsounded portion of the sparse SRS band; processing unmasked patch embeddings representing an unmasked portion of the sparse SRS band using first transformer blocks; decoding the unmasked patch embeddings and adding zero vectors to the masked patch embeddings to generate a vector sequence representing the unmasked patch embeddings and the masked patch embeddings; processing the vector sequence using second transformer blocks to predict SRS for the masked patch embeddings based on self-attention; and reconstructing the full band SRS based on the processed vector sequence. The sparse SRS band input to the AI model may be in a frequency and antenna domain. The 2D image of the sparse SRS band may be divided into the patches in the frequency and antenna domain. The method 1500 may further include: after dividing the 2D image into the patches, applying a DFT to the patches to convert the patches from the frequency and antenna domain to an antenna and delay domain; or after dividing the 2D image into the patches, applying the DFT to the patches to convert the patches from the frequency and antenna domain to the antenna and delay domain and concatenating the converted patches to the sparse SRS band input to the AI model.

Although FIG. 15 illustrates one example of an AI-based channel inpainting method 1500, various changes may be made to FIG. 15. For example, while shown as a series of steps, various steps in FIG. 15 may overlap, occur in parallel, occur in a different order, or occur any number of times (including zero times).

Although this disclosure has been described with exemplary embodiments, various changes and modifications may be suggested to one skilled in the art. It is intended that this disclosure encompass such changes and modifications as fall within the scope of the appended claims. None of the description in this application should be read as implying that any particular element, step, or function is an essential element that must be included in the claims scope. The scope of patented subject matter is defined by the claims. None of the description in this application should be read as implying that any particular element, step, or function is an essential element that must be included in the claim scope. The scope of patented subject matter is defined only by the claims.

What is claimed is:

1. A method comprising:
transmitting, by a first electronic device, configuration information for sounding reference signals (SRSs) to second electronic devices, the configuration information including non-uniform sampling patterns for the SRSs;
receiving, by the first electronic device, non-uniformly sampled SRSs over respective channels from the second electronic devices based on the configuration information;
preprocessing the non-uniformly sampled SRSs to extract channel state information of the channels; and
reconstructing, using an artificial intelligence (AI) model trained to perform channel inpainting, a full band SRS for each of the channels based on the channel state information.

2. The method of claim 1, further comprising:
identifying a sub-band including the non-uniformly sampled SRSs from allocated resource symbols for each of the channels;
combining identified sub-bands from the resource symbols to generate a sparse SRS band for each of the channels;
inputting the sparse SRS band of each of the channels to the AI model;
applying, using the AI model, the channel inpainting to reconstruct the full band SRS of each of the channels; and
performing a wireless communication task based on the full band SRSs of the channels.

3. The method of claim 2, wherein reconstructing the full band SRS comprises:
dividing a two-dimensional (2D) image of the sparse SRS band into patches to generate patch embeddings;
masking patch embeddings representing an unsounded portion of the sparse SRS band;
processing unmasked patch embeddings representing an unmasked portion of the sparse SRS band using first transformer blocks;
decoding the unmasked patch embeddings and adding zero vectors to the masked patch embeddings to generate a vector sequence representing the unmasked patch embeddings and the masked patch embeddings;
processing the vector sequence using second transformer blocks to predict SRS for the masked patch embeddings based on self-attention; and
reconstructing the full band SRS based on the processed vector sequence.

4. The method of claim 3, wherein:
the sparse SRS band input to the AI model is in a frequency and antenna domain; and
the 2D image of the sparse SRS band is divided into the patches in the frequency and antenna domain.

5. The method of claim 4, further comprising:
after dividing the 2D image into the patches, applying a discrete Fourier transform (DFT) to the patches to convert the patches from the frequency and antenna domain to an antenna and delay domain; or
after dividing the 2D image into the patches, applying the DFT to the patches to convert the patches from the frequency and antenna domain to the antenna and delay domain and concatenating the converted patches to the sparse SRS band input to the AI model.

6. The method of claim 2, wherein the AI model is trained by:
calculating a loss function using at least one of a sounded portion of the sparse SRS band or an unsounded portion of the sparse SRS band; or
denoising the sounded portion of the sparse SRS band.

7. The method of claim 2, wherein the AI model is trained by:
injecting a noiseless channel with a timing and frequency offset (TFO) impairment to a model input to the AI model and an input to a label generation module, the model input comprising the sparse SRS band;
adding noise to the model input;
masking an unsounded portion of the sparse SRS band;
applying a TFO estimation and compensation to the model input;
compensating generated labels with the TFO estimation; and
aligning the model input and the labels in time and frequency.

8. A first electronic device comprising:
memory; and
a processor operably coupled to the memory, the processor configured to:
transmit configuration information for sounding reference signals (SRSs) to second electronic devices, the configuration information including non-uniform sampling patterns for the SRSs;
receive non-uniformly sampled SRSs over respective channels from the second electronic devices based on the configuration information;
preprocess the non-uniformly sampled SRSs to extract channel state information of the channels; and
reconstruct, using an artificial intelligence (AI) model trained to perform channel inpainting, a full band SRS for each of the channels based on the channel state information.

9. The first electronic device of claim 8, wherein the processor is further configured to:
identify a sub-band including the non-uniformly sampled SRSs from allocated resource symbols for each of the channels;
combine identified sub-bands from the resource symbols to generate a sparse SRS band for each of the channels;
input the sparse SRS band of each of the channels to the AI model;
apply, using the AI model, the channel inpainting to reconstruct the full band SRS of each of the channels; and
perform a wireless communication task based on the full band SRSs of the channels.

10. The first electronic device of claim 9, wherein to reconstruct the full band SRS, the processor is further configured to:
divide a two-dimensional (2D) image of the sparse SRS band into patches to generate patch embeddings;
mask patch embeddings representing an unsounded portion of the sparse SRS band;
process unmasked patch embeddings representing an unmasked portion of the sparse SRS band using first transformer blocks;
decode the unmasked patch embeddings and adding zero vectors to the masked patch embeddings to generate a vector sequence representing the unmasked patch embeddings and the masked patch embeddings;
process the vector sequence using second transformer blocks to predict SRS for the masked patch embeddings based on self-attention; and
reconstruct the full band SRS based on the processed vector sequence.

11. The first electronic device of claim 10, wherein:
the sparse SRS band input to the AI model is in a frequency and antenna domain; and
the 2D image of the sparse SRS band is divided into the patches in the frequency and antenna domain.

12. The first electronic device of claim 11, wherein the processor is further configured to:
after dividing the 2D image into the patches, applying a discrete Fourier transform (DFT) to the patches to convert the patches from the frequency and antenna domain to an antenna and delay domain; or
after dividing the 2D image into the patches, applying the DFT to the patches to convert the patches from the frequency and antenna domain to the antenna and delay domain and concatenating the converted patches to the sparse SRS band input to the AI model.

13. The first electronic device of claim 9, wherein AI model is trained by at least one of:
calculating a loss function using at least one of a sounded portion of the sparse SRS band or an unsounded portion of the sparse SRS band; or
denoising the sounded portion of the sparse SRS band.

14. The first electronic device of claim 9, wherein AI model is trained by:
injecting a noiseless channel with a timing and frequency offset (TFO) impairment to a model input to the AI model and an input to a label generation module, the model input comprising the sparse SRS band;
adding noise to the model input;
masking an unsounded portion of the sparse SRS band;
applying a TFO estimation and compensation to the model input;
compensating generated labels with the TFO estimation; and
aligning the model input and the labels in time and frequency.

15. A non-transitory computer readable medium embodying a computer program, the computer program comprising program code that, when executed by a processor of a first electronic device, causes the first electronic device to:
transmit configuration information for sounding reference signals (SRSs) to second electronic devices, the configuration information including non-uniform sampling patterns for the SRSs;
receive non-uniformly sampled SRSs over respective channels from the second electronic devices based on the configuration information;
preprocess the non-uniformly sampled SRSs to extract channel state information of the channels; and
reconstruct, using an artificial intelligence (AI) model trained to perform channel inpainting, a full band SRS for each of the channels based on the channel state information.

16. The non-transitory computer readable medium of claim 15, further comprising program code that, when executed by the processor of the first electronic device, causes the first electronic device to:
identify a sub-band including the non-uniformly sampled SRSs from allocated resource symbols for each of the channels;
combine identified sub-bands from the resource symbols to generate a sparse SRS band for each of the channels;
input the sparse SRS band of each of the channels to the AI model;
apply, using the AI model, the channel inpainting to reconstruct the full band SRS of each of the channels; and
perform a wireless communication task based on the full band SRSs of the channels.

17. The non-transitory computer readable medium of claim 16, wherein:
the program code that, when executed by the processor of the first electronic device, causes the first electronic device to reconstruct the full band SRS comprises program code that, when executed by the processor of the first electronic device, causes the first electronic device to:
divide a two-dimensional (2D) image of the sparse SRS band into patches to generate patch embeddings;
mask patch embeddings representing an unsounded portion of the sparse SRS band;
process unmasked patch embeddings representing an unmasked portion of the sparse SRS band using first transformer blocks;
decode the unmasked patch embeddings and adding zero vectors to the masked patch embeddings to generate a vector sequence representing the unmasked patch embeddings and the masked patch embeddings;
process the vector sequence using second transformer blocks to predict SRS for the masked patch embeddings based on self-attention; and
reconstruct the full band SRS based on the processed vector sequence.

18. The non-transitory computer readable medium of claim 17, wherein:
the sparse SRS band input to the AI model is in a frequency and antenna domain; and
the 2D image of the sparse SRS band is divided into the patches in the frequency and antenna domain.

19. The non-transitory computer readable medium of claim 18, further comprising program code that, when executed by the processor of the first electronic device, causes the first electronic device to:
after dividing the 2D image into the patches, applying a discrete Fourier transform (DFT) to the patches to convert the patches from the frequency and antenna domain to an antenna and delay domain; or
after dividing the 2D image into the patches, applying the DFT to the patches to convert the patches from the frequency and antenna domain to the antenna and delay domain and concatenating the converted patches to the sparse SRS band input to the AI model.

20. The non-transitory computer readable medium of claim 16, wherein the AI model is trained by:
injecting a noiseless channel with a timing and frequency offset (TFO) impairment to a model input to the AI model and an input to a label generation module, the model input comprising the sparse SRS band;
adding noise to the model input;
masking an unsounded portion of the sparse SRS band;
applying a TFO estimation and compensation to the model input;
compensating generated labels with the TFO estimation; and
aligning the model input and the labels in time and frequency.
